(19) United States
(12) Patent Application Publication
(10) Pub. No.: US 2009/0062700 A1
(43) Pub. Date: Mar. 5, 2009

(54) FACE-CONTOUR-COMPLIABLE EYESHADE

(76) Inventor: Pin-Hung Lin, Taipei (TW)

Correspondence Address: LEONG C LEI, PMB # 1008, 1867 YGNACIO VALLEY ROAD, WALNUT CREEK, CA, 94598, US

(21) Appl. No.: 12/193,043

(22) Filed: Aug. 17, 2008

(30) Foreign Application Priority Data
Aug. 31, 2007 (TW) 096132382

(51) Int. Cl. A61H 5/00; A61H 1/00; A61H 7/00

(52) U.S. Cl. 601/37; 601/46; 601/84

(57) ABSTRACT

A face-contour-compliable eyeshade includes a hollow shade member in which a flexible unit is arranged. The flexible unit has predetermined resiliency, such as being made of metals, plastics, rubbers, and other flexible and bendable materials, for flexibly bending and shape setting, and has a shape corresponding to a portion around the user's eyes and is further provided with a plurality of bosses and a vibration unit that is attached thereto at a predetermined location, whereby the shade member is shape adjustable in order to comply with the user's face contour for tightly attaching to and engaging the portion around the eyes so that the vibration unit can make the plurality of bosses to vibrate for effecting acupressure and massage on acupuncture points around the eyes and the shade member is foldable for easy carrying.

### TECHNICAL FIELD OF THE INVENTION

The present invention generally relates to a design of eyeshade, and more particularly to an eyeshade that is shape-adjustable to comply with a user's face contour for tightly attaching to and engaging a portion around the user's eyes to carry out massage of acupuncture points around the eyes and has the advantages of being eye ergonomic and easy to carry.

### DESCRIPTION OF THE PRIOR ART

With the prosperous development of modern business and industry, modern people are always kept in a busy condition, which prevents the eyes from taking sufficient rest, eventually resulting in poor health of the eyes. According to statistic data, a lot of modern people are suffering poor eye health.

Due to urbanization, high buildings and skyscrapers exit around urban residents, making the urban residents staying in narrowed spaces. Due to frequent use of the eyes in short distances, and also due to long term playing of video games, modern children are severe suffering eyesight troubles. Such problems must be treated as early as possible. However, it is often too late to carry out proper treatment when the problems are discovered.

Thus, it is recently emphasized that the eyes must be cared properly to release tiredness and maintain in a relaxed condition. Although devices and medication for eye caring are readily available in the market, most of the therapeutic devices are only of a single function, which, besides the difficulty of operation, provides effectiveness that is so far unsatisfactory.

The present inventor, who has been devoted himself to the development of portable eye massage devices, attempts to made further improvement to these and other known devices in order to provide an eye health caring device that is compact, eye-ergonomic, and easy to carry.

### SUMMARY OF THE INVENTION

An objective of the present invention is to provide a flexibly bendable and adjustable massage eyeshade, of which the structure comprises a shade member, which is provided with straps for wearing; a flexible unit, which is arranged in the shade member and is made of flexible and bendable materials for bending and shape setting, the flexible unit comprising a plurality of bosses; a vibration unit, which is arranged in the shade member and generates vibration; and a power source unit, which is coupled to the shade member by a holder, the holder containing therein a battery and comprising a control unit, wherein the flexible unit allows the shade member to be adjustable and deformable in order to comply with a user's face contour for tightly attaching to and engaging with portions around the eyes of the user and the vibration unit causes the plurality of bosses to vibrate for effecting acupressure and massage on acupuncture points around the eyes. The shade member is foldable and collapsible for easy carrying.

The shade member forms an opening.

The opening of the shade member is provided with fastening parts for closing/opening the shade member.

The flexible unit is made of aluminum based materials.

The flexible unit forms a notch that is shaped to substantially correspond to the portion of the eyes. The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a face-contour-compliable eyeshade in accordance with the present invention.

FIG. 2 is an exploded view of the eyeshade of the present invention taken from a front perspective.

FIG. 3 is an exploded view of the eyeshade of the present invention taken from a rear perspective.

FIG. 4 is a schematic view illustrating the eyeshade of the present invention worn on the face of a user.

FIG. 5 is also a schematic view illustrating the eyeshade of the present invention worn on the face of a user.

FIG. 6 shows the eyeshade of the present invention in a folded condition.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

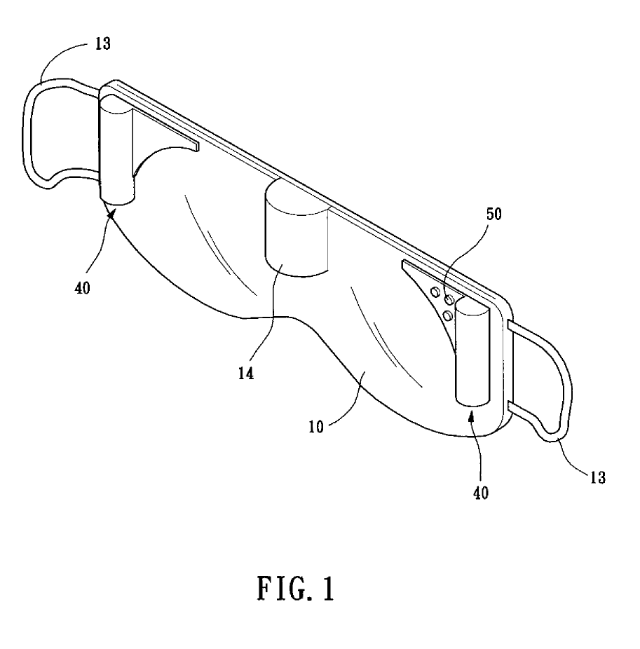

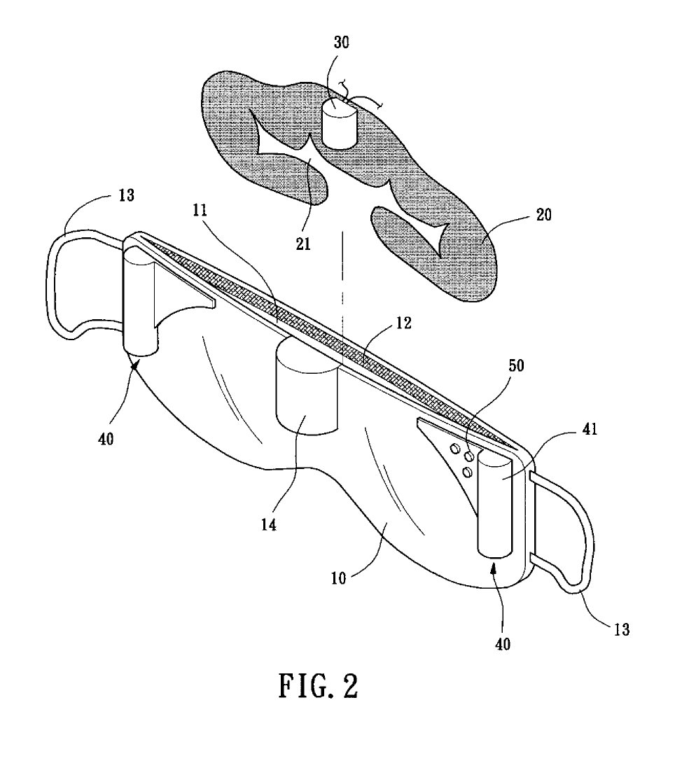

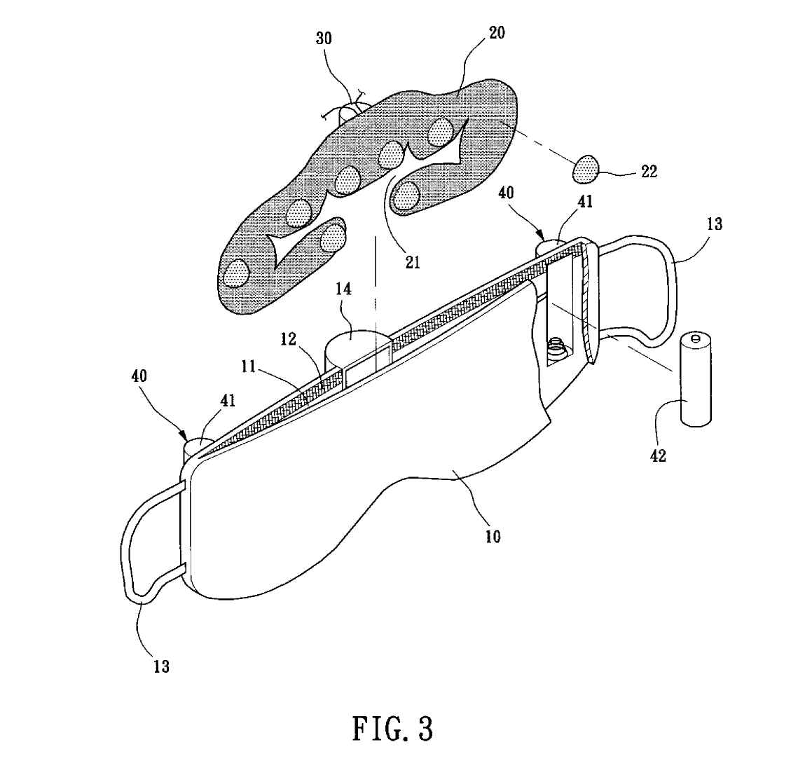

As shown in FIGS. 1-3, structurally, the present invention comprises a shade member 10, a flexible unit 20 arranged in the shade member 10, a vibration unit 30 attached to the flexible unit 20, and two power source units 40 arranged in the shade member 10. The flexible unit 20 features predetermined resiliency, which allows for flexible bending for shape setting to make the shape complying with a circumferential portion of a user's eyes, and is provided with a plurality of bosses 22, whereby the shade member 10 is adjustable and deformable to comply with the user's face contour for tightly attaching and engaging the user's eyes. By means of the operation of the vibration unit 30, the bosses 22 are vibrated to carry out acupressure and massage with respect to acupuncture points around the eyes. Further, the shade member 10 is easily bendable for easy carrying. A more detailed description will be given below:

The shade member 10 is made of fabric materials and forms an opening 11 for receiving constituent components. The opening 11 is provided with fastening parts 12 for closing and opening the shade member 10. Opposite ends of the shade member 10 are respectively provided with straps 13, which can be made of resilient materials, to fit over the user's ears in a resiliently stretchable and comfortable manner.

The flexible unit 20 is arranged in the shade member 10 and has predetermined resiliency, such as being made of metals, plastics, rubbers, or other flexible or bendable materials. In a preferred embodiment of the present invention, the flexible unit 20 is made of aluminum or tin based materials, so as to have the shape set and fixed after being flexibly bent. The flexible unit 20 forms a notch or opening 21 that is shaped to substantially correspond to the circumferential portion of the user's eyes and is provided with the plurality of bosses 22 that correspond in location to the acupuncture points around the eyes.

The vibration unit 30 generates vibration (which can be realized with a motor with an eccentric shaft) and is attached to the flexible unit 20. The shade member 10 forms, at a predetermined location, a receptacle 14 that receives and retains the vibration unit 30.

The power source units 40 each comprise a holder 41 mounted to the shade member 10 and a battery 42 is arranged inside the holder 41 to supply power to the vibration unit 30. One of the holders 41 is provided with a control unit 50 that control switching on/off of the power sources and the operation of the vibration unit 30.

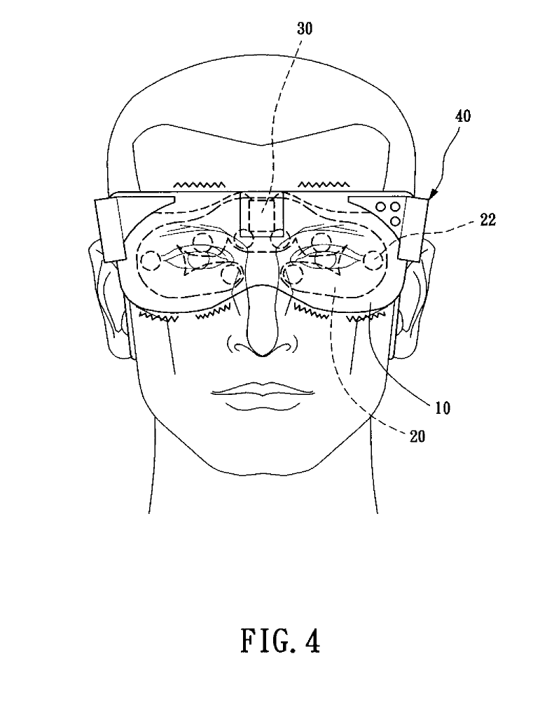

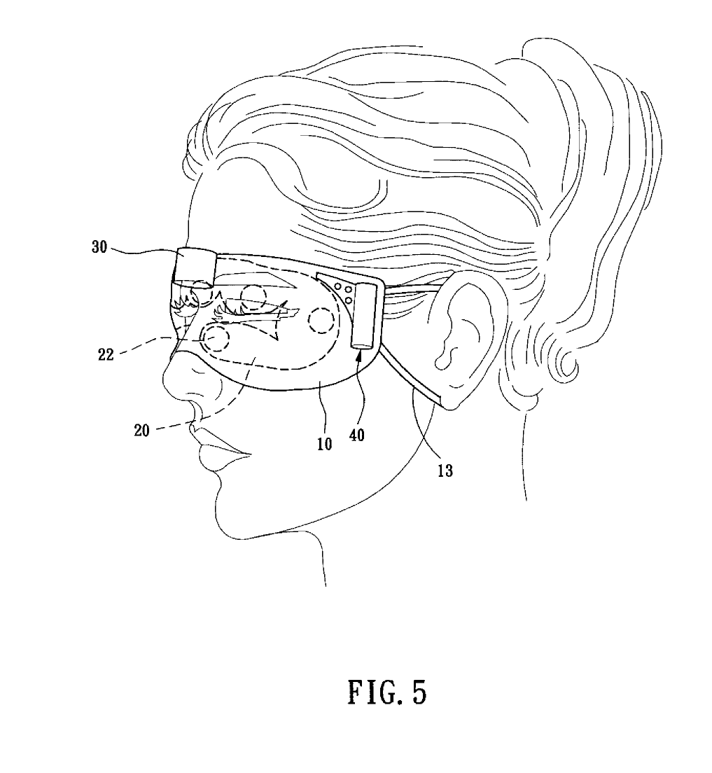

Referring to FIGS. 4 and 5, to use the present invention, the shade member 10 is worn on the eyes of the user. It is noted here that due to the flexible bendability of the flexible unit 20, the shade member 10 can be adjusted and deformed in order to comply with the user's face contour and thus tightly attach to and engage with portions around eyes in an eye-ergonomic manner. By means of the vibration generated by the vibration unit 30 and transmitted to the flexible unit 20, the plurality of bosses 22 of the flexible unit 20 is caused to vibrate and effect acupressure and massage on the acupuncture points around the eyes.

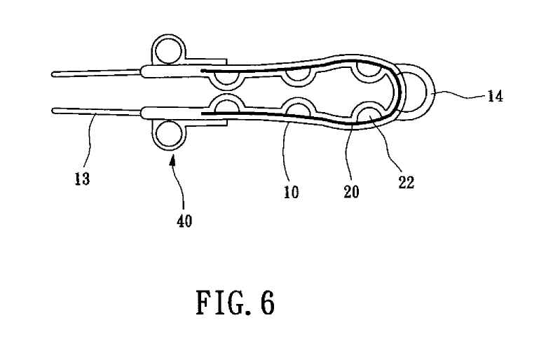

Referring to FIG. 6, due to the flexible bendability of the flexible unit 20, the shade member 10 of the present invention can be easily folded and collapsed, becoming compact for easy carrying.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A face-contour-compliable eyeshade, comprising:
a shade member, which is provided with straps for wearing;
a flexible unit, which is arranged in the shade member and is made of flexible and bendable materials for bending and shape setting, the flexible unit comprising a plurality of bosses;
a vibration unit, which is arranged in the shade member and generates vibration; and
a power source unit, which is coupled to the shade member by a holder, the holder containing therein a battery and comprising a control unit;
wherein with the above elements, the flexible unit provides the shade member with shape adjustability and deformability for complying a user's face contour and thus tightly attaching to and engaging with portions around the eyes of the user, whereby the vibration unit causes the plurality of bosses to vibrate for effecting acupressure and massage on acupuncture points around the eyes and wherein the shade member is foldable and collapsible for easy carrying.

2. The face-contour-compliable eyeshade according to claim 1, wherein the shade member forms an opening.

3. The face-contour-compliable eyeshade according to claim 2, wherein the opening of the shade member is provided with fastening parts for closing/opening the shade member.

4. The face-contour-compliable eyeshade according to claim 1, wherein the flexible unit is made of aluminum based materials.

5. The face-contour-compliable eyeshade according to claim 1, wherein the flexible unit forms a notch that is shaped to substantially correspond to the portion of the eyes.
